(19) United States
(12) Patent Application Publication
(10) Pub. No.: US 2017/0032315 A1
(43) Pub. Date: Feb. 2, 2017

(54) AERIAL PARCEL DELIVERY

(71) Applicants: Vishal GUPTA, Sunnyvale, CA (US); Larron FRITZ, Sunnyvale, CA (US)

(72) Inventors: Vishal GUPTA, Sunnyvale, CA (US); Larron FRITZ, Sunnyvale, CA (US)

(21) Appl. No.: 15/303,016

(22) PCT Filed: Apr. 10, 2015
(86) PCT No.: PCT/US2015/025456

§ 371 Date: Oct. 13, 2016

Related U.S. Application Data
(60) Provisional application No. 61/978,945, filed on Apr. 13, 2014.
(60) Provisional application No. 61/991,559, filed on May 11, 2014.

(51) Int. Cl. G06Q 10/08; G06Q 10/02; H04L 29/08; B64C 39/02

(52) U.S. Cl. CPC G06Q 10/0832; B64C 39/024; G06Q 10/02; H04L 67/18; B64C 2201/128

(57) ABSTRACT

In one aspect, a method includes registering a recipient platform, receiving a request to reserve a delivery date or time for a delivery of a parcel to a name or an address, identifying the recipient platform as being associated with the name or the address, and creating a reservation for the delivery. The method further includes generating information describing a position and an environment of the recipient platform, and providing the information to the delivery entity. In one aspect, a system includes a receiving area and a trigger wire structure. The trigger wire structure includes posts and one or more trigger wires strung between the posts. The posts are positioned around a periphery of the receiving area, and the trigger wire is positioned above the receiving area. The trigger wire is positioned to direct a parcel dropped near the trigger wire onto the receiving area.

### CROSS-REFERENCE TO RELATED PATENT APPLICATIONS

This application claims the benefit of U.S. Provisional Patent Applications 61/978,945 filed Apr. 13, 2014 to Fritz et al., titled “A system for a network of locations for facilitating UAV operations,” and 61/991,559 filed May 11, 2014 to Gupta et al., titled “A system for a network of locations for facilitating UAV operations,” the contents of which are incorporated herein by reference in their entirety.

### BACKGROUND

The field of this disclosure is aerial parcel delivery. Challenges to aerial parcel delivery include protection of the delivery vehicle, protection of persons during a delivery, and identification of delivery sites.

### SUMMARY

In one aspect, a system includes a receiving area and a trigger wire structure. The trigger wire structure includes posts and one or more trigger wires strung between the posts. The posts are positioned around a periphery of the receiving area and the trigger wire is positioned above the receiving area. The trigger wire is positioned to direct a parcel dropped near the trigger wire onto the receiving area.

In another aspect, a device includes a receiving area to accept a parcel delivered from an aerial vehicle, a wireless first communication interface for communication with the aerial vehicle; an environment detector, a second communication interface for communication via a network; and circuitry to provide a representation of information received at the environment detector to one or both of the first communication interface and the second communication interface.

In another aspect, a method includes receiving at a recipient platform information regarding an expected parcel delivery, activating an environment detector, and providing a representation of information received from the environment detector to an aerial vehicle. The method further includes identifying that a parcel was received at the recipient platform, and providing information regarding the parcel to a communication interface.

In another aspect, a method includes registering a recipient platform in a memory of a computing device, receiving a request from a delivery entity to reserve a delivery date or time for a delivery of a parcel to a name or an address, identifying the recipient platform as being associated with the name or the address, and creating a reservation for the delivery. The method further includes generating information describing a position of the recipient platform and an environment of the recipient platform, and providing the information to the delivery entity. The method further includes receiving an environment update from the recipient platform, providing at least a portion of the environment update to an aerial vehicle of the delivery entity, receiving a notice from the recipient platform that the parcel was delivered, and generating a notification that the parcel was delivered.

### BRIEF DESCRIPTION OF THE DRAWINGS

FIG. 1 is a representation of an embodiment of a parcel delivery system.

FIG. 2 is a block diagram of an example of a computing device.

FIG. 3 provides examples of types of information that may be stored in a parcel delivery system.

FIG. 4 provides a flow diagram of example communications in an embodiment of a parcel delivery system.

FIG. 5 is a block diagram of an example of a recipient platform.

FIGS. 6A, 6B, 6C and 6D are examples of positioning a recipient platform or portions thereof.

FIGS. 7A and 7B are representations of an embodiment of a recipient platform.

FIGS. 8A and 8B are representations of another embodiment of a recipient platform.

### DETAILED DESCRIPTION

The present disclosure describes a system, devices, and techniques for delivery of parcels. Although embodiments are described with respect to automated delivery using unmanned vehicles, persons of ordinary skill in the art will recognize that the concepts of the present disclosure extend to include the use of manned vehicles, and further extend to include manual delivery. In this disclosure, aerial parcel delivery is described; however, the concepts described extend to include ground parcel delivery.

In one or more embodiments, an unmanned aerial vehicle (UAV) is used to deliver parcels without landing the UAV. In one or more embodiments, manned aerial vehicles may be used alternatively, and as such, a manned aerial vehicle may include access to breathable gases (e.g., an oxygen mix) such as through a mask, or the aerial vehicle may include an enclosed cabin, which may be pressurized and/or may include breathable gases.

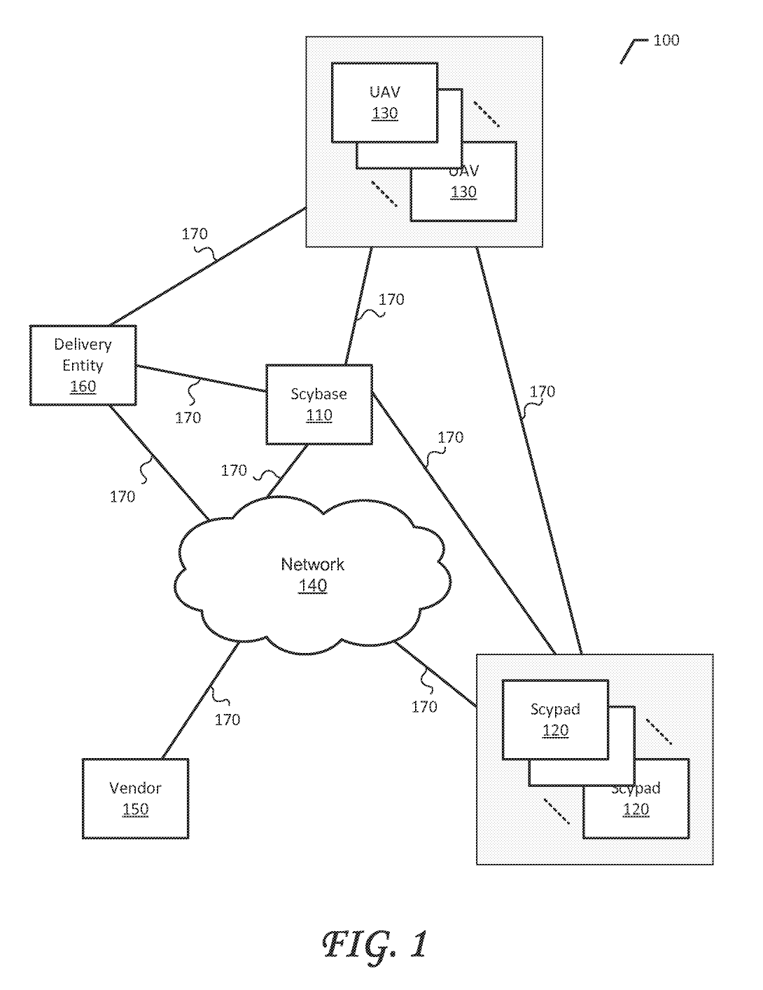

FIG. 1 provides a general overview in diagram form for a system 100 for aerial delivery of parcels according to an embodiment of this disclosure. System 100 includes a virtual centralized repository of information, referred to as Scybase 110 in FIG. 1, which may be implemented in one physical location or may be distributed across two or more physical locations. System 100 further includes one or more recipient platforms, referred to as Scypad 120 in FIG. 1, which provide for receipt of parcels via aerial delivery. Parcels are dropped, lowered, or otherwise delivered to a receiving area of Scypad 120. FIG. 1 further includes a depiction of multiple UAVs 130 that may access Scybase 110 for information related to Scypads 120. Scybase 110, Scypads 120 and UAVs 130 may communicate with each other via a network 140. Communication within system 100 may include security measures, such as authentication and authorization measures.

Scybase 110 may include, for example, one or more databases with information related to Scypads 120, such as location, platform, model, version, attachments and modifications. Information related to a Scypad 120 may be manually entered during a registration of the Scypad 120 in Scybase 110, may be entered through scanning of an identifier on the Scypad 120 which is then sent to Scybase 110 through network 140 (e.g., in an email, text, or other data string, including packetized data strings), may be automatically retrieved from the Scypad 120 through network 140, or by way of other registration techniques. For example, during manufacture, a Scypad 120 may be initially registered with platform model and configuration, where registration may be manual, via an identifier scan, through a communication interface, or using a test equipment (e.g., a bed of nails); when later powered up, the Scypad 120 may communicate with Scybase 110 to verify platform model and version, and to provide updates with respect to attachments and modifications, or location e.g., global positioning system (GPS) coordinates). In one or more embodiments, the information related to a Scypad 120 includes communication abilities of the Scypad 120 (e.g., an ability to communicate via Wi-Fi, Internet, or satellite communication) and reception abilities (e.g., an ability to receive large parcels or fragile parcels, an ability to receive oddly-shaped parcels or specific types of containers, or an approval to receive hazardous materials).

Scybase 110 may further include a control protocol for scheduling deliveries to Scypads 120 based on requests from vendors (e.g., vendor 150), requests from delivery entities (e.g., delivery entity 160), requests from Scypads 120, or requests from UAVs 130.

The Scypad 120 may further provide to Scybase 110 information specific to the environment in which the Scypad 120 is located. Such environment-specific information may be provided at initial power-up, periodically, at a set time, when moved, randomly, when conditions change, or upon request; or, when a delivery is scheduled, en route, impending, or in progress. Environment-specific information includes, but is not limited to, one or more of a location (e.g., a GPS location, a cellular network triangulated location, or a vertical placement or height of Scypad 120), a clearance around Scypad 120, a weather condition (e.g., a temperature, an air pressure, a wind speed, a humidity, an altitude, a density, or a presence of rain), or a present or a potential interference (e.g., an obstruction, an approach restriction, a moving person in close proximity, an electromagnetic interference, a weather condition warning, a malfunctioning equipment, or other interference that could inhibit a delivery).

There may be many different vendors of Scypads 120. There may be many different types and models of Scypads 120 that may range from modest to highly sophisticated.

A Scypad 120 may be as modest as a target with recognizable features, such as a specific marking, a specific shape, a bar code or other visual identification code, a color combination, a logo or other picture, or other recognizable features. The recognizable feature(s) are sized to be visible to a UAV 130. In one or more embodiments, the target may be reusable, such as a waterproof material. In one or more embodiments, the target may be single use, such as a paper printed out when an item has been ordered for delivery to a specific address. In embodiments where Scypad 120 is a target with one or more recognizable features, the coarse location of Scypad 120 may be determined from an address associated with the target, and the fine location determined from identifying the recognizable features. For example, a UAV 130 delivering the parcel to the target Scypad 120 goes to the location associated with the address, and searches for a target with recognizable features, such as by using pattern recognition software.

A Scypad 120 may be highly sophisticated, such as including a computing device, communication capability, and environment detectors. An environment detector may be a sensor, a camera, a microphone, a light detector, or other environment detector. An environment detector may, for example, detect temperature, air pressure, wind speed, humidity, altitude, density, presence of rain, obstructions, approach restrictions, presence, motion (e.g., a moving person in close proximity), electromagnetic interference, or malfunctioning equipment. Scypad 120 may include mechanical devices for moving parcels to and from a receiving surface.

In one or more embodiments, Scypad 120 may have capabilities such as one or more of a capability to identify its own location, evaluate its environment, schedule its own deliveries from multiple sources, receive and offload parcels, provide parcels for delivery, detect interference, or abort deliveries.

A Scypad 120 may be designed for specific types of deliveries. For example, in one or more embodiments, a specific container may be used to deliver chemicals, which container is a specific shape, and a Scypad 120 that is designed to receive such specifically shaped chemical containers may have a receptacle with an interior surface matching the shape of the exterior surface of the chemical container. In this way, the chemical container (or other container of specific shape in other embodiments) may be delivered in a more gentle or precise manner. An example of a specific shape is a conical-shaped container with a corresponding conical Scypad 120 receptacle, allowing for guidance of the container into a resting position by way of the conical-shaped receptacle. In one or more embodiments, a returnable container encapsulates the parcel. In one or more embodiments, an enclosure is lowered to the receiving area of Scypad 120, then opens to eject the parcel.

UAVs 130 may be of many different types and models, and may be from many different manufacturers. Some examples of UAVs 130 include a fixed-wing UAV, a multi-rotor copter UAV, a balloon, a blimp, and a dirigible.

UAV 130 may receive information related to Scypads 120 from Scybase 110, and/or directly from Scypads 120. For example, UAV 130 may receive general information about a recipient Scypad 120 from Scybase 110, such as model number and GPS location, then receive specific information from the recipient Scypad 120, such as refined location information, interference information, and weather conditions. In another example, UAV 130 may receive no information from the recipient Scypad 120, and thus may rely on information from Scybase 110.

Network 140 represents one or more networks used for communication between Scybase 110, Scypads 120, UAVs 130, Vendor 150, and Delivery Entity 160. Such networks include public and private networks, static and ad hoc networks, wired and wireless networks, wide-area networks (WANs), local-area networks (LANs), personal-area networks (PANs), cellular networks, satellite networks, and other networks. Communication between Scybase 110, Scypads 120, UAVs 130, Vendor 150, and Delivery Entity 160 may cross multiple networks. Each of Scybase 110, Scypads 120, UAVs 130, Vendor 150, and Delivery Entity 160 may include a capability to communicate across one or more networks 140, using the associated standard or proprietary protocol(s) of the networks. For example, Scypad 120 may include Wi-Fi communication capability for direct communication with UAV 130, or for indirect communication with UAV 130; or, may include Wi-Fi communication ability for indirect communication with UAV 130 by way of a router to an Internet connection to Scybase 110, which then provides information related to Scypad 120 to UAV 130 through cellular or satellite communications.

One or more Vendors 150 may provide items to be delivered, and one or more Delivery Entities 160 may provide delivery services, as will be described below by way of example.

Some functionality of system 100 may be implemented as computer-executable instructions executed by a computing device. For example, some functionality of each of Scybase 110, Vendor 150 and Delivery Entity 160 may be implemented on one or more servers or other computing devices, Scypad 120 may include a computing device, and UAV 130 may include a computing device. Further, computing devices may be used to communicate with Scybase 110, Scypads 120, UAVs 130, Vendor 150 and Delivery Entity 160 directly or through network 140.

Communication between the components of FIG. 1 (e.g., Scybase 110, Scypads 120, UAVs 130, Vendor 150 and Delivery Entity 160) are illustrated in FIG. 1 as being through connections 170, which are wired, wireless, or a combination of wired and wireless interfaces between the components, and between the components and network 140. For example, Vendor 150 may have a wireless connection within a LAN, and a wired connection from the LAN to network 140. For another example, UAV 130 may have one or more of satellite, Wi-Fi, Bluetooth, 3G or 4G cellular, infrared, radio frequency, or other communication interfaces, in addition to a capability for wired connection (e.g., while landed). Further, Scypads 120 may communicate with each other or other devices, and UAVs 130 may communicate with each other or other devices, including air traffic control devices.

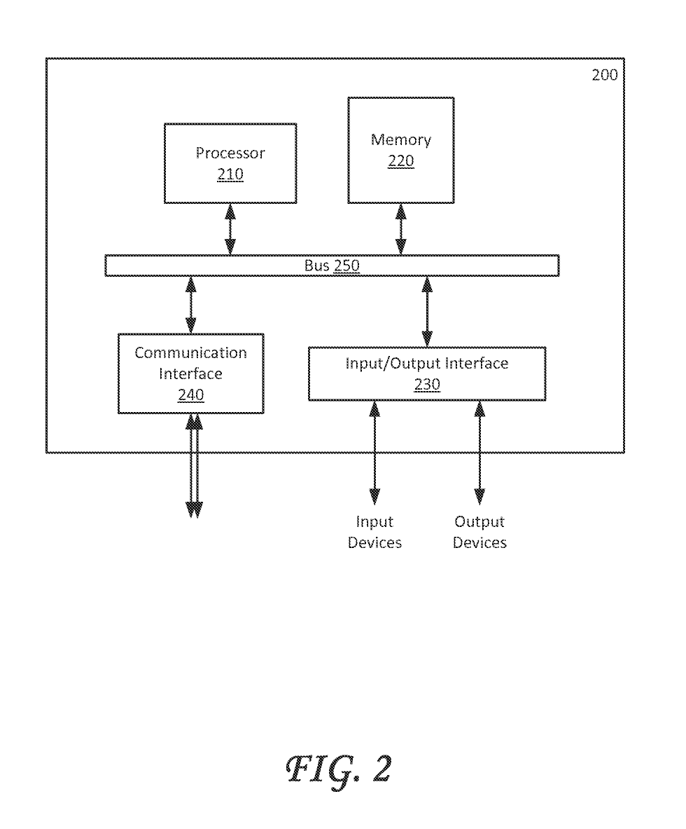

FIG. 2 illustrates an example of a computing device 200 that includes a processor 210, a memory 220, an input/output interface 230, and a communication interface 240. A bus 250 provides a communication path between two or more of the components of computing device 200. The components shown are provided by way of illustration and are not limiting. Computing device 200 may have additional or fewer components, or multiple of the same (or similar) component.

Processor 210 represents one or more of a general-purpose processor, a digital signal processor, a microprocessor, a microcontroller, an application specific integrated circuit (ASIC), a field programmable gate array (FPGA), other circuitry effecting processor functionality, or a combination thereof, along with associated logic.

Memory 220 represents one or both of volatile and non-volatile memory for storing information (e.g., instructions and data). Examples of memory include semiconductor memory devices such as EPROM, EEPROM and flash memory devices, magnetic disks such as internal hard disks or removable disks, magneto-optical disks, CD-ROM and DVD-ROM disks, and the like.

Portions of system 100 may be implemented as computer-readable instructions in memory 220 of computing device 200, executed by processor 210.

Input/output interface 230 represents electrical components and optional code that together provide an interface from the internal components of computing device 200 to external components. Examples include a driver integrated circuit with associated programming.

Communication interface 240 represents electrical components and optional code that together provides an interface from the internal components of computing device 200 to external networks, such as network 140.

Bus 250 represents one or more interfaces between components within computing device 200. For example, bus 250 may include a dedicated connection between processor 210 and memory 220 as well as a shared connection between processor 210 and multiple other components of computing device 200.

An embodiment of the disclosure relates to a non-transitory computer-readable storage medium (e.g., a memory 220 or other medium) having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (PLDs), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

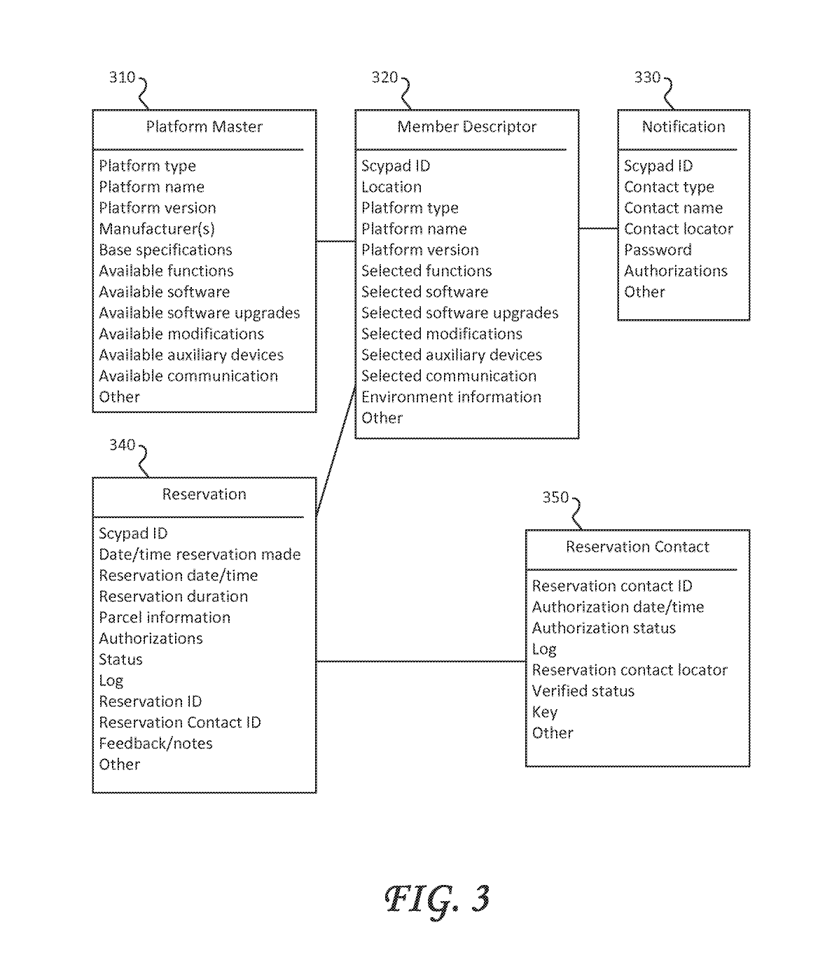

FIG. 3 provides an example of types of information that may be stored and maintained by Scybase 110 in a memory (e.g., memory 220). Illustrated for this example are five repositories: a Platform Master 310 repository, a Member Descriptor 320 repository, a Notification 330 repository, a Reservation 340 repository, and a Reservation Contact 350 repository. Information in the repositories may be added, edited or deleted through a user interface of Scybase 110, or via a communication interface of a computing device (e.g., communication interface 240 of computing device 200) to Scybase 110.

Platform Master 310 repository includes information regarding each of the types of Scypads 120 presently known to Scybase 110. Such information may include one or more of a platform type, a platform name, a platform version, a manufacturer(s), base specifications (e.g., a size, a shock capacity, a weight limit for received parcels, a dimension limit for received parcels, or a functionality), an available function, an available software, an available software upgrade, an available modification, an available upgrade, an available auxiliary device, an available communication capability, or other information. As can be appreciated, there may be multiple entries for each platform type to encompass the different specifications that may apply to different available configurations of the platform type.

Member Descriptor 320 repository includes information describing each of the individual Scypads 120 presently known to Scybase 110, which may include information about Scypads 120 that are not presently enabled or in use. Information includes a Scypad 120 identifier (e.g., an identification number, a name, a URL address, a Wi-Fi device name, or other identifier), a location (e.g., a coarse location, a fine location, an auxiliary position information, or a height above ground or other walking area), and may include one or more of a platform type, a platform name, a platform version, a selected function, a selected software, a selected software upgrade, a selected, modification, a selected auxiliary device, a selected communication capability, or other information (e.g., an API interface type(s), a privacy setting, a notification setting, a user identifier, a public key, or other descriptive information related to Scypad 120). The term ‘selected’ in this regard indicates selected and implemented (e.g., downloaded or attached) at manufacture or post-manufacture. Further, Member Descriptor 320 repository may include environment information, such as a status (e.g., active or enabled), an altitude, a present weather, a weather log, a connectivity status, a last update time, a network address (e.g., IPV4 or IPV6 address), an available network, a reception strength, or other information related to the environment of Scypad 120.

In one or more embodiments, location information may be received by Scybase 110 through network 140 from a person having ownership or control of Scypad 120. In one or more embodiments, location information may be received by Scybase 110 through network 140 directly from Scypad 120. Location information may be, for example, GPS coordinates, triangulation information, or a signal fingerprint of devices in the proximity of Scypad 120

Notification 330 repository includes information about persons associated with Scypads 120, such as those having ownership or authorization to control Scypads 120. Such information includes a Scypad 120 identifier (e.g., an identification number, a name, or other identifier), and may include one or more of a contact type, a contact name, a contact locator (e.g., a phone number, an email address, a URL, or other locator), an authorization, a password, or other information related to the person or persons associated with Scypad 120.

Reservation 340 repository includes information related to pending delivery reservations. Such information includes a Scypad 120 identifier (e.g., an identification number, a name, or other identifier) at an intended delivery site, and may include one or more of a date and time that the reservation was requested, a requested date and time for delivery, a reservation duration, information about the parcel to be delivered (e.g., a size, a shape, a weight, a dimension, a content, or other information), authorization for the reservation and delivery, a status of the reservation or the parcel to be delivered to the Scypad 120, a log (e.g., a log of movement of the parcel to be delivered to the Scypad 120, or a log of communications related to the reservation), a reservation identifier e.g., an identification number, a name, or other identifier), a reservation contact identifier (e.g., a name, an identification number, or other identifier), a note, a feedback, or other information related to the reservation.

Reservation Contact 350 repository includes information related to persons making or having made delivery reservations. Such information includes a reservation contact identifier (e.g., a name, an identification number, or other identifier), and may further include one or more of an authorization date and time for authorization to make reservations, an authorization status, a log (e.g., a log of reservations associated with the reservation contact identifier), a reservation contact locator (e.g., a phone number, an email address, a URL, or other locator), a verified status, a key, or other information related to persons making or having made delivery reservations.

By way of example (referring to FIGS. 1, 2 and 3), a Buyer associated with Scypad 120 may place an order for an Item on a mobile computing device 200 (e.g., smart phone) via a communication interface 240 (e.g., a Wi-Fi connection), which order traverses network 140 (e.g., the Internet) and is received by Vendor 150. The order includes an address of the Buyer. Vendor 150 locates such an item (e.g., by accessing an inventory database in memory 220), and contacts Scybase 110 to request a delivery reservation for delivery of the item to the name and/or address in the order. To request a delivery reservation, Vendor 150 provides a reservation request and information to populate Reservation Contact 350 repository, or, if already in Reservation Contact 350 repository, provides information such as a reservation contact identifier to auto-populate part of a reservation request. The reservation request may include information about the packaged Item, such as size, weight, contents, or special delivery instructions. Scybase 110 identifies a Scypad 120 in Member Descriptor 320 repository from the name and/or address in the order, and creates a reservation in Reservation 340 repository. Scybase 110 then verifies that the identified Scypad 120 has the capability to receive the requested delivery, such as whether the identified Scypad 120 is functional, in place, durable enough to accept the parcel weight when dropped or otherwise delivered, has an appropriately shaped receptacle for the parcel, and so forth. Such verification may be achieved by a review of the information in Member Descriptor 320 and Platform Master 310 repositories. If the identified Scypad 120 has the capability to accept the requested delivery of the parcel, Scybase 110 may notify one or both of the Buyer and Vendor 150 of the capability, and may also determine contact information for a person associated with the Scypad 120 from Notification 330 repository, and send a notification to the person. If the identified Scypad 120 does not have the capability to accept the delivery of the parcel, Scybase 110 may notify one or both of the Buyer and Vendor 150 of the lack of capability, and may also notify a person associated with the identified Scypad 120, as found in Notification 330 repository.

Note that, in the example, the Buyer may include a Scypad 120 identifier in the order instead of, or additionally to, a name or an address. In this case, the reservation request by Vendor 150 may include the Scypad 120 identifier.

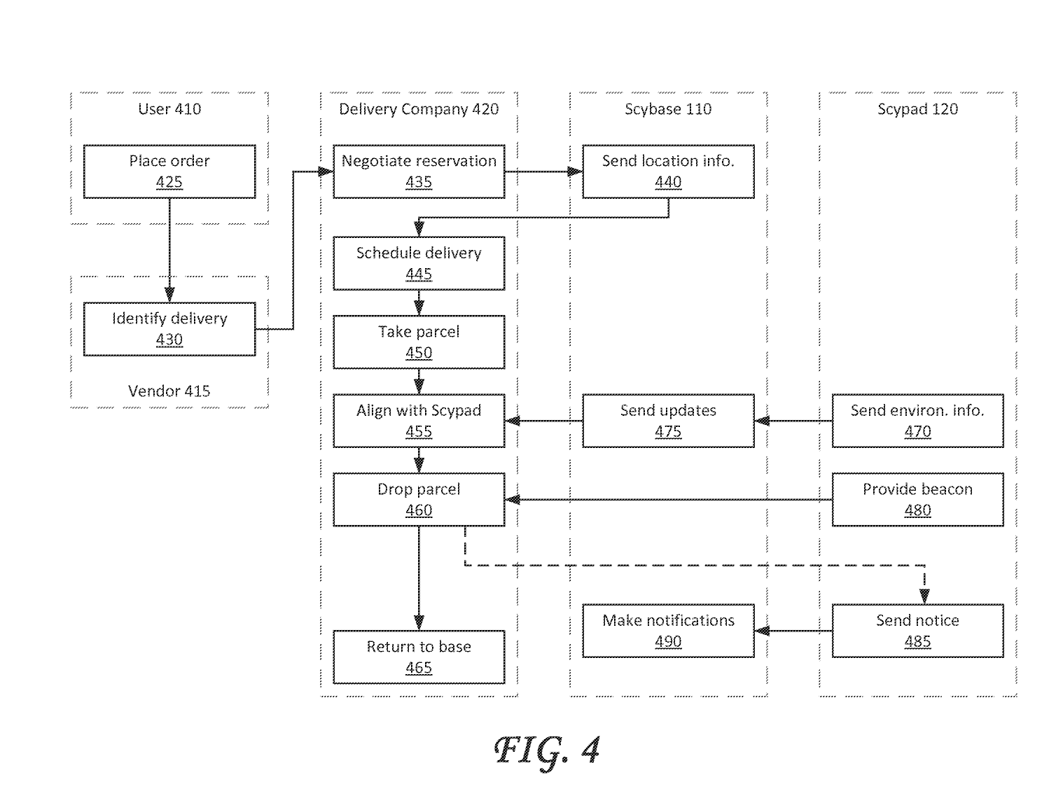

FIG. 4 illustrates an example of an order and delivery in accordance with an embodiment of the present disclosure. The example is provided by way of a flow diagram of activities of a User 410, a Delivery Company 420, a Vendor 415, Scybase 110, and a Scypad 120, including an illustration of communications between User 410, Delivery Company 420, Vendor 415, Scybase 110, and Scypad 120. In this example, Scypad 120 is already registered with Scybase 110 (e.g., there is an associated Scypad identifier, and an entry in Member Descriptor 320 repository), and Delivery Company 420 has already registered with Scybase 110 (e.g., there is an associated reservation contact identifier, and an entry in Reservation Contact 350 repository).

As shown in FIG. 4 for this example, User 410 orders (at 425) from Vendor 415 an item to be delivered to Scypad 120. Vendor 415 communicates (at 430) with Delivery Company 420, identifying that the item is to be delivered. Delivery Company 420 negotiates (at 435) a reservation (e.g., comes to an agreement on a date and time for delivery) with Scybase 110. Scybase 110 creates the reservation, and sends (at 440) location information of Scypad 120 and other information (e.g., capabilities of Scypad 120) to Delivery Company 420. Delivery Company 420 schedules (at 445) the delivery. At the scheduled date and time, the packaged item is taken (at 450) to the general location of Scypad 120 by a UAV, the UAV vertically aligns (at 455) with Scypad 120, and drops (at 460) or otherwise delivers the parcel towards Scypad 120, and returns (at 465) to base (or continues with the next delivery). In one or more embodiments, Scypad 120 may provide (at 470) environment information to Scybase 110, and Scybase 110 updates Scypad 120 environment information in Member Descriptor 320 repository, which may be accessed by Delivery Company 420 or by the UAV prior to or during UAV flight. Alternatively, in one or more embodiments, Scypad 120 may provide (at 470) environment information to Scybase 110, Scybase 110 updates Scypad 120 environment information in Member Descriptor 320 repository, and Scybase 110 makes (at 490) notifications to Delivery Company 420. Scypad 120 may additionally or alternatively communicate directly with the UAV to provide environment information. In one or more embodiments, Scypad 120 provides (at 480) a beacon signal for the UAV when the UAV is positioned near Scypad 120, to facilitate the drop (at 460) or other delivery of the parcel.

In one or more embodiments, when the parcel is dropped (at 460) or otherwise delivered, Scypad 120 performs bookkeeping activities, such as, for example, registering receipt of the parcel, providing (at 485) a notice to Scybase 110 (or alternatively or additionally to one or more of the UAV, Delivery Company 420, Vendor 415 or User 410), or updating a log. A notice may include, for example, that the parcel was received, a maximum impact force to the delivered parcel, a time of delivery, an identification of the aerial vehicle, a weight of the parcel, or a delivery technique used to deliver the parcel. In one or more embodiments, Scypad 120 electronically issues a delivery receipt (e.g., to one or more of the UAV, Scybase 110, User 410, Vendor 415 or Delivery Company 420), and may further digitally sign such a delivery receipt. In one or more embodiments, Scypad 120 provides a notice (at 485) to Scybase 110, which in turn provides a notification (at 490) to a contact in Notification 330 repository associated with the User 410 or a person owning or controlling Scypad 120 (or to one or both of Vendor 415 and Delivery Company 420).

In one or more embodiments, Vendor 415 and Delivery Company 420 may be a combined entity. In one or more embodiments, Delivery Company 420 and Scybase 110 may be a combined entity. In one or more embodiments, Vendor 415 may package the item into a parcel prior to pick-up by Delivery Company 420; alternatively, Delivery Company 420 may package the item to be delivered.

Scypad 120, when used for a delivery, is physically located in a space accessible from overhead, such as a yard or garden, a driveway, a rooftop, a parking lot, and so forth. In one or more embodiments, Scypad 120 is located at a height above a walking level (e.g., ground level), such as on a platform several feet or yards above the yard or other location. Such an elevated position may reduce the number of potential obstructions for flight or for parcel delivery. When an elevated position is used, Scypad 120 may include a chute or a guide wire for transporting parcels to a walking level, or may include a multi-stage drop structure, such as a drop pad on the elevated platform along with a drop pad at walking level, where either or both of the drop pads may include techniques for reducing impact on a parcel, as described below.

As described above, in one or more embodiments, Scypad 120 may include features recognizable by UAV 130, and may include a beacon for UAV 130. A beacon may be, for example, a light or a pattern of lights, an infrared light, a radio frequency (RF) transmission, a sonic or ultrasonic signal, a general packet radio system (GPRS) transmission, a Wi-Fi, Zigbee, or Bluetooth transmission, or other beacon. The beacon may provide a consistent signal (e.g., a steady light, or an RF transmission at a specific frequency and phase), or may be a variable signal (e.g., a flashing light, a light pattern, a signal encoded by amplitude modulation, frequency modulation, or phase modulation of light, infrared light, or RF, or a signal using a standardized communication protocol).

In one or more embodiments, Scypad 120 includes a guiding mechanism for delivery of parcels. For example, Scypad 120 may include a horizontal wire or set of crossed wires used by UAV 130 for more precise location, or for tethering. For example, wires may be used for alignment using visual recognition to identify the location of the wire(s), for tethering using a tethering device (e.g., a hook with optional locking device) or a retractable docking cable with tethering device. Further, UAV 130 may air-dock on the wire(s) for storage or refueling of the UAV 130. Air-docking may be especially useful for UAVs 130 that are lighter than the surrounding air, such as an unmanned autonomous balloon (UAB), in that air-docking reduces risk and complexity in landing and taking off. A docking cable (e.g., with a tethering device) may include not only tethering capability, but also may provide for refueling or data transmission, and may be used for acquiring or delivering a parcel. Speed and acceleration of descent and ascent of a docking cable may be controlled, such as through motors and brakes. A docking cable may be detachable, such that when entangled, or when pulled from below. UAV 130 may detach the docking cable from UAV 130.

UAV 130 may include a capability to eject a parcel upon detecting an impending crash, and activate protection or notification devices on the parcel such as a parachute, siren or light.

In an embodiment in which UAV 130 is a UAB, compensation for a change in weight when a parcel is acquired or delivered (or when a payload shifts) may be provided by way of using compressed air or gas in the UAB to adjust three-dimensional positioning. Additionally, a UAB (or other UAV 130) may have suction and exhaust ports for hover, thrust, and vertical movement control. A UAB may have a streamlined shape to reduce wind drag, and adjustable fins to accommodate changes in wind direction. A UAB may have multiple gas-filled (e.g., air-filled) chambers to withstand localized damage. A UAB (or other UAV 130) may have an energy-producing solar outer cover. Generally, UAV 130 may be solar-powered, and may additionally carry or include an alternative energy source or energy source capability (e.g., wind energy conversion).

UAV 130 may be designed to include components manufacturable using three-dimensional printing, so that UAV 130 is repairable in the field.

In one or more embodiments, Scypad 120 includes a trigger wire that is used to trigger UAV 130 to release a parcel. For example, when UAV 130 is positioned over Scypad 120 (e.g., using coarse location coordinates, by honing in on a beacon, or other positioning technique), contact with the trigger wire of Scypad 120 indicates to UAV 130 that it is positioned properly to drop the parcel. Contact with the trigger wire may be through a dangling wire or through a hanging extension such as a rod, and a trigger may be a mechanical trigger such as a sensing of a movement of the rod, or an electrical, trigger such as a sensing of a change in impedance at the wire. In the examples above, the dangling wire or hanging rod may be retractable, and deployed when the UAV 130 is in the proximity of Scypad 120. Upon detection of the trigger wire, a signal is provided to a release device that is securing the parcel to UAV 130, and the release device disengages to allow the parcel to drop to Scypad 120. A signal to the release device may be provided by a computing device of UAV 130, or the signal may be provided automatically (mechanically or electrically) when the trigger wire is detected.

In one or more embodiments, UAV 130 includes a cable with a release mechanism (e.g., a latch) at the end. For example, when UAV 130 is positioned over Scypad 120 (e.g. using coarse location coordinates, by honing in on a beacon, or other positioning technique), contact with a trigger wire of Scypad 120 with a predefined level of force causes the release mechanism to disengage the parcel. In one or more embodiments, the release mechanism includes a lock that is controlled by UAV 130, by Scypad 120 or by Scybase 110, such that the release mechanism cannot disengage until a signal is sent to the lock to cause it to unlock.

In one or more embodiments, UAV 130 includes a cable designed to break at a predefined level of force. For example, when UAV 130 is positioned over Scypad 120 (e.g., using coarse location coordinates, by honing in on a beacon, or other positioning technique), and the cable contacts a trigger wire of Scypad 120, the cable breaks, and a portion of the cable attached to the parcel drops with the parcel. In one or more embodiments, UAV 130 includes a cable designed to break at a predefined level of force, with a weight positioned along the cable. The cable may be designed to break within a certain portion of the cable, and a weight may be positioned below the parcel, such that when the weight snags a trigger wire of Scypad 120, the pull of the weight causes a force equal to or greater than the predefined level of force to be applied along the cable, and the portion of the cable thus breaks. The weight may be positioned above the parcel, and the cable may be designed to break within a certain portion of the cable or anywhere along the cable; when the weight snags a trigger wire of Scypad 120, the pull of the weight causes a force equal to or greater than the predefined level of force to be applied along the cable, and the cable thus breaks at the certain portion if so designed, or otherwise breaks above the weight. A weight may be, for example, a ball, a disc, a hook, or other item which, when snagged by the trigger wire of Scypad 120, will hold the trigger wire long enough to create a level of force greater than the predefined level of force to break the cable, and thereby drop the parcel onto a receiving area of Scypad 120.

Note that when two or more trigger wires are implemented for Scypad 120, an intersection of trigger wires may assist in positioning of a dropped parcel to land in a certain portion of the receiving area of Scypad 120. For example, an intersection of trigger wires may position a parcel to drop near the center of the receiving area. For another example, an intersection of trigger wires may position a parcel to drop at an offset from the center, such as to allow for multiple parcel drops on different parts of the receiving area. For a further example, an intersection of trigger wires may position a parcel to drop on a particular portion of the receiving area, such as a fragile parcel to drop in a padded or otherwise shock-absorbing portion of the receiving area, or such as a shaped container to land in a shaped receptacle of the receiving area.

In one or more embodiments, positioning of trigger wires may be selective, such that the trigger wires may be positioned according to type, size, weight, shape, or contents of a parcel, for example, or according to a number of parcel deliveries expected. Positioning may be two-dimensional positioning or three-dimensional positioning.

A trigger wire may be positioned in parallel to a walking level, or alternatively may be positioned with an inclination relative to the walking level.

The trigger wire described in the above examples may be one of multiple trigger wires. For example, there may be two perpendicular trigger wires crossed (e.g., with approximately 90 degree angles between), two non-perpendicular trigger wires crossed (e.g., at angles other than approximately 90 degrees between), two uncrossed trigger wires at an angle with respect to each other, or two trigger wires substantially parallel to each other. There may be three or more trigger wires crossed, substantially parallel to each other, or uncrossed at angles with respect to each other, or a combination thereof (e.g., two trigger wires substantially parallel, with a third trigger wire crossed over one or both of the other two). When multiple trigger wires are used, the trigger wires may be positioned at different heights and with different inclinations with respect to a walking level.

In one or more embodiments, Scypad 120 includes a guide wire to which a parcel is attached for delivery (e.g., for improved location precision, or for slower parcel delivery to minimize impact). In embodiments using a guide wire, the guide wire may include a parcel receptacle such as a basket for receiving the parcel; alternatively or additionally, a parcel may itself be fitted with a guide wire attachment. Further in embodiments using a guide wire, a braking device may be incorporated into the parcel receptacle, into the guide wire attachment, or into a guide wire spooler, to limit speed or acceleration. A braking device may include a capability to be controlled remotely, such that UAV 130 or Scypad 120 (or Scybase 110) is able to adjust braking based on feedback from local sensors at Scypad 120. For example, Scypad 120 may include pressure sensors to facilitate a determination of when and how much to adjust the braking. Pressure sensors may be used independently of a guide wire system, such as to report on an impact of a parcel on Scypad 120. A parcel may be fitted with pressure sensors that report to one or more of Scypad 120, UAV 130, Vendor 150, or Delivery Entity 160. In the embodiment described above with respect to a conical-shaped receptacle for a conical-shaped container, for example, pressure sensors may be employed in one or positions in the conical-shaped receptacle (and/or on the conical-shaped container) for real-time feedback in positioning the container.

In one or more embodiments, Scypad 120 includes shock absorbers or shock absorbing material(s) at the receiving area, and may further include adjustable shock absorbers or shock absorbing material(s) that are adjusted during a parcel delivery to reduce impact forces on the parcel. For example, Scypad 120 may initiate deployment of a shock-absorbing device just prior to a parcel delivery.

In one or more embodiments, the receiving area of Scypad 120 is a trampoline-style structure, that includes a material which stretches upon impact to reduce impact forces on a dropped parcel, in one or embodiments, the receiving area of Scypad 120 is an airbag structure, with one or more airbags that are normally deployed, or are deployed before or during a parcel delivery, or a combination thereof.

In one or more embodiments, the receiving area of Scypad 120 includes a net for catching parcels. Alternatively or additionally, a net may be included for a UAV 130 to cling to or crash into, such as for temporary landing or for crash landing. Such nets may be attached to movable arms, and may be deployed upon request (e.g., by request of UAV 130 or Scypad 120, by manual switch or the like, or by other manual deployment).

In one or more embodiments, the receiving area of Scypad 120 may be, or may include, a chute into which a parcel is dropped and thereby directed to a landing area.

Scypad 120 may include multiple techniques for reducing impact forces on a parcel, such as including two or more of guide wire, net, shock absorbers, shock absorbing material(s), trampoline, or airbag structures.

In one or more embodiments, Scypad 120 includes sensors, such as weight sensors and code readers, that detect characteristics (e.g., a weight or an imprinted code) of the parcel, for example as a verification that the expected parcel was delivered.

In addition to receiving parcel deliveries. Scypad 120 provides services to UAV 130 in one or more embodiments, such as refueling (e.g., using gasoline, hydrogen, or electricity) or landing capability for emergency landing of UAV 130. Refueling may be provided on the ground or in air, and may include suitable refueling devices (e.g., a conductive, inductive, or laser projection energy transfer device, or a fueling tube). Refueling may be provided free or at a charge; thus, Scypad 120 may include devices for measuring fuel delivered, and devices for performing a monetary or other bartering transaction.

In one or more embodiments, Scypad 120 includes techniques for reduction of energy consumption, such as techniques for going into a sleep mode when not in use. Scypad 120 may include a recharging capability, such as including solar panels.

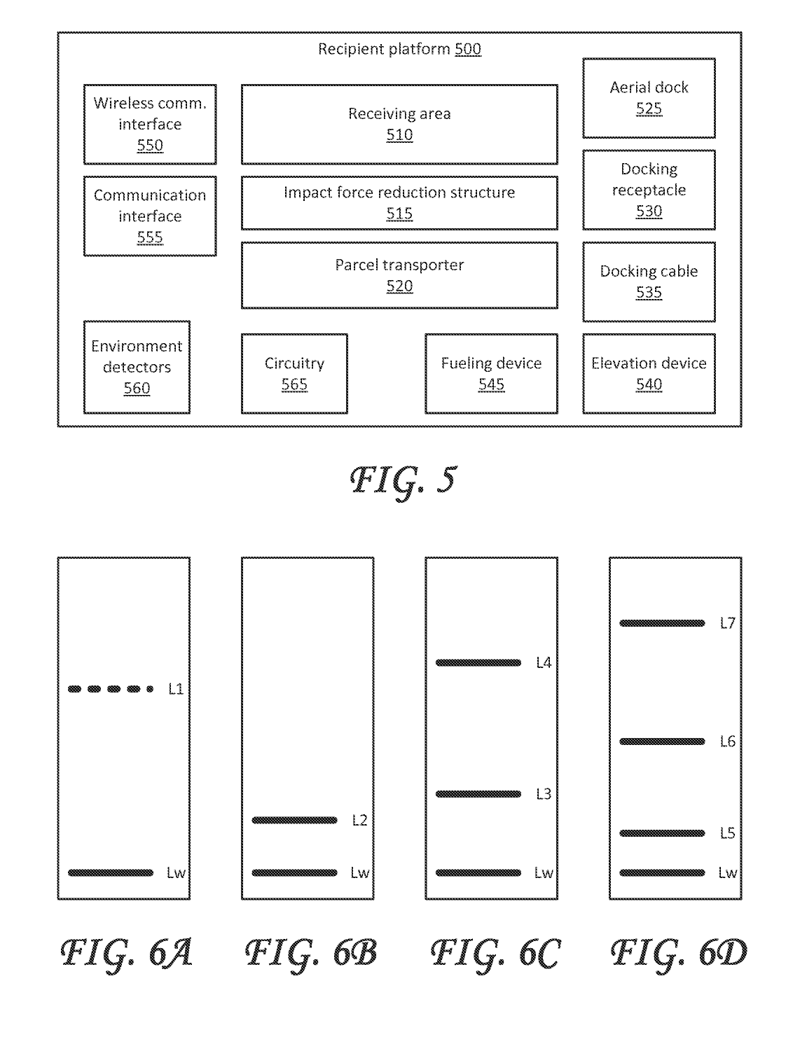

FIG. 5 is a block diagram of an example of a recipient platform 500 (e.g., Scypad 120) according to an embodiment of this disclosure. Recipient platform 500 includes a receiving area 510 upon which a parcel is delivered. In one or more embodiments, an impact force reduction structure 515 is attached to, or incorporated into, receiving area 520. Impact force reduction structure 515 may be, for example, a guide wire, a net, a shock absorber, a shock absorbing material, a trampoline, or an airbag structure, as described above. In one or more embodiments, a parcel transporter 520 may be attached to receiving area 510, or otherwise incorporated into recipient platform 500, for moving parcels on and off of receiving area 510. For example, parcel transporter 520 may be used for moving parcels from UAV or elsewhere to receiving area 510, moving parcels from receiving area 510 to a UAV, or moving parcels from receiving area 510 to elsewhere, such as to a pallet, or generally such as moving parcels off of receiving area 510 to prepare for a next parcel delivery. Parcel transporter 520 may be, or may include, for example, a chute, a guide wire, a rope and pulley system, a winch, or a conveyor belt.

In one or more embodiments, recipient platform 500 includes an aerial dock 525, which may be, for example, a raised platform, a single wire, a set of wires, or a net.

In one or more embodiments, a docking receptacle 530 is provided on recipient platform 500. Docking receptacle 530 is an attachment structure that connects, for example, to one or more of a towline, an anchor, a gaseous delivery pipe or hose (e.g., for inflation of air pockets, such as in a balloon or dirigible, or for provision of breathable gases), a fuel delivery pipe or hose (e.g., for delivery of liquid or gaseous fuels), a fuel delivery conductor (e.g., for electrical power transfer by way of inductive or conductive coupling), a fuel delivery light pipe (e.g., for optical power transfer by way of light coupling), a communication channel (e.g., twisted pair wires, shielded wires, or coaxial cable), or a guide wire. Docking receptacle 530 provides such attachments for a docking cable lowered from a UAV, or for a docking cable positioned on recipient platform 500. Docking receptacle 530 may include sensors or a computing device (e.g., computing device 200), such as for guiding a docking cable during coupling with a UAV.

In one or more embodiments, a docking cable 535 is provided on recipient platform 500. Included with docking cable 535 is an elevation device 540 for elevating docking cable 535 to a UAV, such as a pulley system or a winch, which may be manual or automatic. Docking cable 535 may include one or more of a towline, and anchor, a gaseous delivery pipe or hose, a fuel delivery pipe or hose, a fuel delivery conductor, a fuel delivery light pipe, a communication channel, or a guide wire. Docking cable 535 may include sensors or a computing device (e.g., computing device 200), such as for guiding docking cable 535 during coupling with a UAV.

In embodiments in which recipient platform 500 provides fueling capability, either through docking receptacle 530 or docking cable 535, a fueling device 545 includes a fuel source and a fuel delivery capability. For example, for liquid or gaseous fuels, fueling device 545 may include a storage tank and a pump, along with appropriate coupling connectors to couple to docking receptacle 530 or docking cable 535. Fueling device 545 may be similarly configured (e.g., storage container and pump) for a gaseous delivery. For another example, for electrical power transfer, fueling device 545 may include one or more of an electrical generator, a storage battery, or a connection to a utility power grid, along with appropriate coupling connectors to couple to docking receptacle 530 or docking cable 535. For another example, for optical power transfer, fueling device 545 may include a light source (e.g., LED, halogen, incandescent, fluorescent, infrared, or laser light source), along with appropriate coupling connectors to couple to docking receptacle 530 or docking cable 535. In one or more embodiments, fueling device 545 is outfitted for provisioning through both docking receptacle 530 and through docking cable 535.

In one or more embodiments, recipient platform 500 includes a wireless communication interface 550 (e.g., communication interface 240), which may be used to communicate with UAVs that are within a transmission range. Wireless communication interface 550 may also be used to communicate with other components of recipient platform 500, such as receiving area 510, impact force reduction structure 515, parcel transporter 520, aerial dock 525, docking receptacle 530, docking cable 535, elevation device 540, fueling device 545, environment detectors 560, or other component. Further, wireless communication interface 550 may be used to communicate with devices external to recipient platform 500, such as communication via Wi-Fi with a device in a nearby building, communication via Bluetooth with a mobile computing device, communication via satellite link or cellular network, and so forth.

In one or more embodiments, recipient platform 500 includes an additional communication interface 555 (e.g., communication interface 240), which may be wired. In one or more embodiments, docking receptacle 530 includes a connection to communication interface 555, for establishing a communication link through docking cable 535 or through a docking cable lowered from a UAV. For example, a communication link may be used to provide status, delivery receipts, news, entertainment, instructions, fine positioning directions, and so forth.

In one or more embodiments, recipient platform 500 includes environment detectors 560, such as one or more of a sensor, a camera, a microphone, a light detector, or other environment detector. An environment detector may, for example, detect temperature, air pressure, wind speed, humidity, altitude, density, presence of rain, obstructions, approach restrictions, presence, motion, electromagnetic interference, or malfunctioning equipment.

In one or more embodiments, recipient platform 500 includes circuitry 565, such as circuitry included in computing device 200 (FIG. 2). For example, circuitry 565 may include a processor (e.g., processor 210), memory (e.g., memory 220), communication interfaces (e.g., communication interfaces 560 and 570), and input/output interfaces (e.g., input/output interface 230). Input/output interfaces may be used, for example, to communicate with one or more of receiving area 510, impact force reduction structure 515, parcel transporter 520, aerial dock 525, docking receptacle 530, docking cable 535, elevation device 540, fueling device 545, environment detectors 560, or other component.

Recipient platform 500 may include portions at different elevations, as discussed above.

FIGS. 6A-6D illustrate examples of some ways in which portions of recipient platform 500 may be positioned at different elevations. The positioning is discussed in terms of levels Lw and L1-L7. Level Lw indicates a walking level, such as ground level, or the pavement level on a corresponding floor of a parking structure, or roof level on top of a building. Levels L1-L7 indicate elevations above level Lw. Level L4 indicates an elevation above level L3, but does not indicate a relative elevation with respect to level L2. Similarly, level L7 indicates an elevation above levels L5 and L6, and level L6 indicates an elevation above level L5, but levels L5-L7 do not indicate a relative elevation with respect to levels L2-L4.

In FIG. 6A, recipient platform 500 is positioned at one level, level Lw or level L1, where level L1 indicates an elevation above level Lw. For example, level L1 may indicate an elevated platform (e.g., 10-100 feet) upon which recipient platform 500 is positioned. In FIG. 6B, portions of recipient platform 500 are positioned at two levels, levels Lw and L2. For example, receiving area 510 may be positioned at level L2, with circuitry 565 at level Lw. In FIG. 6C, portions of recipient platform 500 are positioned at three levels, levels Lw, L3 and L4. For example, aerial dock 525 may be positioned at level L4 (or in the case of a vertical docking wire or net, may extend from level L4 to level L3), a first receiving area 510 may be positioned at level L3, and a guide wire may allow for transport of parcels from the first receiving area 510 at level L3 to a second receiving area 510 at level Lw. In FIG. 6D, portions of recipient platform 500 are positioned at four levels, levels Lw, L5, L6 and L7. For example, aerial dock 525 with docking receptacle 530 may be positioned at level L7, environment detectors 560 may be positioned at levels L7 and L6, fueling device 545 and receiving area 510 may be positioned at level L6, and circuitry 565 may be positioned at level Lw. The examples provided with respect to FIGS. 6A-6D are non-limiting, and other options for multi-level positioning of recipient platform 500 are contemplated and encompassed within the scope of this disclosure.

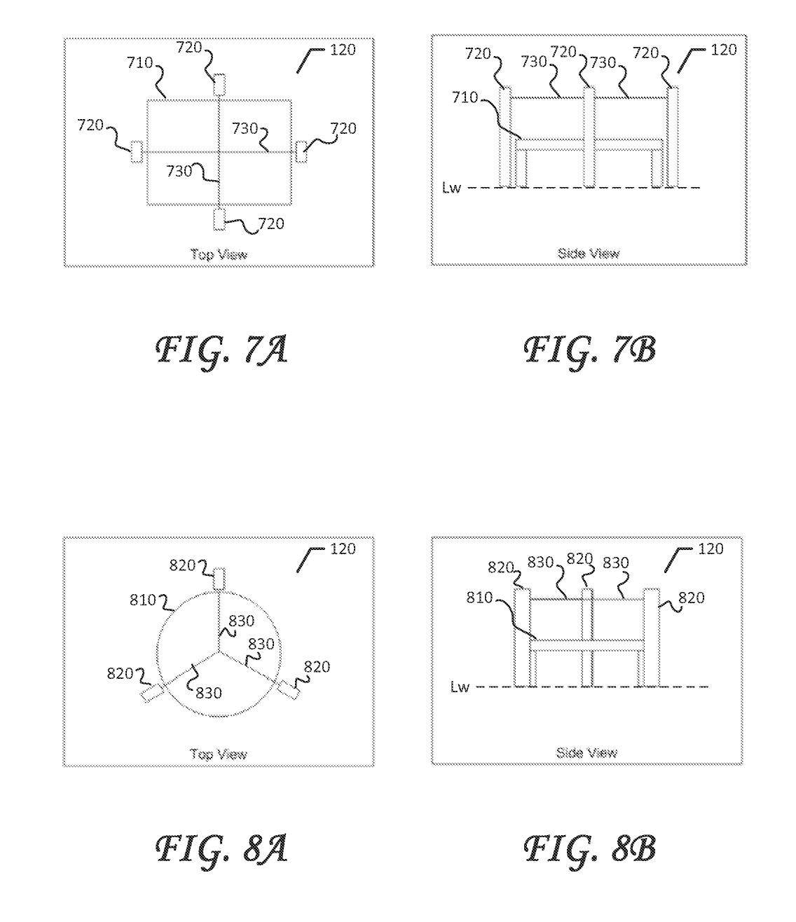

FIGS. 7A and 7B illustrate an example of an embodiment of a Scypad 120, shown in top view (FIG. 7A) and a side view (FIG. 7B). Scypad 120 includes a generally rectangular receiving area 710, and a trigger wire structure surrounding receiving area 710, where the trigger wire structure includes posts 720 and trigger wires 730 strung between posts 720. In the embodiment illustrated in FIG. 7A, two trigger wires 730 are crossed and substantially perpendicular to each other, and as illustrated in FIG. 7B for this embodiment, trigger wires 730 are substantially parallel to a walking level Lw. In one or more embodiments, receiving area 710 is a trampoline. In other embodiments, receiving area 710 is another type of area, such as described above with respect to receiving area 510 (and may include a structure such as described with respect to impact force reduction structure 515).

FIGS. 8A and 8B illustrate another example of an embodiment of a Scypad 120, shown in top view (FIG. 8A) and a side view (FIG. 8B). Scypad 120 includes a generally circular receiving area 810, and a trigger wire structure surrounding receiving area 810, where the trigger wire structure includes posts 820 and trigger wires 830 strung between posts 820. In the embodiment illustrated in FIG. 8A, three trigger wires 830 meet in a central area of the trigger wire structure, and as illustrated in FIG. 8B for this embodiment, trigger wires 830 are substantially parallel to a walking level Lw. In one or more embodiments, receiving area 810 is a trampoline. In other embodiments, receiving area 810 is another type of area, such as described above with respect to receiving area 510 (and may include a structure such as described with respect to impact force reduction structure 515).

The generally rectangular shape of receiving area 710 in FIGS. 7A and 7B and the generally circular shape of receiving area 810 in FIGS. 8A and 8B are non-limiting examples, and other shapes may be implemented instead. For example, polygon shapes other than a rectangle may be implemented. Further, although the trigger wires 730 and 830 cross or meet in a central area of the respective trigger structures and are substantially parallel to a walking level Lw, these examples are non-limiting, and other positioning is also within the scope of this disclosure.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within, the scope of the claims appended hereto. In particular, while certain. methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

1. A system, comprising:
a network of receiving devices to catch at least one parcel from at least one aerial vehicle from a height, wherein each of receiving device of the network of receiving devices has a unique identifier registered with a central computing device mapped to its location and status, and wherein the least one aerial vehicle is operatively coupled with the central computing device and receives the location and status of a desired receiving device based on its respective unique identifier in order to deliver the parcel, and wherein each receiving device comprises:
a receiving area including a shock-reduction portion to catch the at least one parcel; and
a UAV recognizable feature configured to guide the at least one aerial vehicle to the receiving area;
a trigger wire structure, wherein the trigger wire structure includes:
a plurality of posts; and
at least one trigger wire strung between ones of the posts;
wherein the posts of the trigger wire structure are positioned around a periphery of the receiving area, and the trigger wire is positioned above the receiving area; and
wherein the trigger wire is positioned to direct the at least one parcel dropped near the trigger wire onto the receiving area.

2. The system of claim 1, wherein there are two trigger wires, crossed to be substantially perpendicular to each other.

3. The system of claim 1, wherein there are three trigger wires that meet in a central area between the posts.

4. A device for catching a dropped parcel, comprising:
a receiving area configured to accept the parcel that is drop delivered by an aerial vehicle from a height;
a wireless first communication interface configured for communication with the aerial vehicle;
at least one environment detector;
a second communication interface configured for communication via a network; and
circuitry configured to provide a representation of information received at the environment detector to one or both of the first communication interface and the second communication interface, wherein a notification is issued by the device upon receipt of the parcel from the aerial vehicle.

5. The device of claim 4, wherein the receiving area includes a shock absorbing device or material.

6. The device of claim 4, wherein the receiving area includes a trampoline structure.

7. The device of claim 4, wherein the receiving area includes one or more airbag structures.

8. The device of claim 4, further comprising an aerial dock.

9. The device of claim 4, further comprising a docking cable configured to guide the parcel to the receiving area.

10. The device of claim 4, further comprising a docking cable configured to provide fuel to the aerial vehicle.

11. The device of claim 4, wherein the environment detector is one of a temperature sensor, a humidity sensor, a wind sensor, a motion sensor, a presence detector, a camera, a microphone, and a light detector.

12. A method, comprising:
receiving, at a recipient platform of a receiving device that is configured to catch a parcel that is dropped from a height by a aerial vehicle, information regarding an expected parcel delivery;
activating an environment detector configured with the receiving device;
providing a representation of information received from the environment detector to an aerial vehicle;
identifying that a parcel was received at the recipient platform; and
providing information regarding the parcel to a communication interface.

13. The method of claim 12, further comprising initiating deployment of a shock-absorbing device.

14. The method of claim 12, wherein the information regarding the parcel is one of a weight, an impact force, an identification code, a time of delivery, a delivery receipt, a digitally signed delivery receipt, or a combination thereof.

15. The method of claim 12, wherein information received from the environment detector includes one of temperature, air pressure, wind speed, humidity, altitude density, presence of rain, obstructions, approach restrictions, moving persons in close proximity, electromagnetic interference, weather condition warning, malfunctioning equipment, or a combination thereof.

16. A method, comprising:
registering one or more electronically enabled recipient platforms in a memory of a computing device;
receiving a request from a delivery entity to reserve a delivery date or time for delivery of a parcel to a name or an address;
identifying a recipient platform from the one or more electronically enabled recipient platforms as being associated with the name or the address;
creating a reservation for the delivery;
generating information describing a position of the recipient platform and an environment of the recipient platform, and providing the information to the delivery entity;
receiving an environment update from the recipient platform;
providing at least a portion of the environment update to an aerial vehicle or to the delivery entity;
receiving a notice from the recipient platform that the parcel was delivered; and
generating a notification that the parcel was delivered.

17. The method of claim 16, wherein registering the recipient platform includes determining an address from global positioning system (GPS) coordinates received via a network.

18. The method of claim 17, wherein the GPS coordinates are received from the recipient platform.

19. The method of claim 16, wherein the information describing a position of the recipient platform includes a vertical height of the recipient platform.

20. The method of claim 16, wherein the information describing an environment of the recipient platform includes one of a clearance around the recipient platform, a weather condition, a present interference, a potential interference, or a combination thereof.

21. The method of claim 20, wherein the weather condition includes one of a temperature, an air pressure, a wind speed, a humidity, an altitude, a density, a presence of rain, or a combination thereof.

22. The method of claim 20, wherein the potential interference includes one of an obstruction, an approach restriction, a moving person in close proximity, an electromagnetic interference, a weather condition warning, a malfunctioning equipment, or a combination thereof.

23. The method of claim 16, wherein the notice from the recipient platform that the parcel was delivered includes one of information regarding a maximum impact force to the delivered parcel, a time of delivery, an identification of the aerial vehicle, a weight of the parcel, a delivery technique used to deliver the parcel, or a combination thereof.

24. A computing device operatively coupled with a plurality of electronically addressable receiving devices and configured to receive a status message from at least one of the plurality of electronically addressable receiving devices indicating status of the at least one of the plurality of electronically addressable receiving devices, wherein each receiving device of the plurality of electronically addressable receiving devices has:
a unique identifier;
a geo-location that is received at the computing device;
a beacon or insignia for identification and adjusting approach by an automated delivery vehicle; and wherein the plurality of electronically addressable receiving devices are used for accepting parcel deliveries from the vehicle.
